(19) United States
(12) Patent Application Publication
(10) Pub. No.: US 2004/0062904 A1
(43) Pub. Date: Apr. 1, 2004

(54) Vacuum formed vehicle carpet module

(76) Inventors: Jeffrey L. Rice, Chambersburg, PA (US); Dennis C. Young, Mechanicsburg, PA (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/261,818

(22) Filed: Oct. 1, 2002

(51) Int. Cl. B32B 33/00; B29C 51/10

(52) U.S. Cl. 428/95; 264/546; 264/553; 425/388

(57) ABSTRACT

A vehicle carpet module consisting of a piece of tufted carpet that is attached to a piece of thermoplastic material, the module being contoured to the shape of a motor vehicle floor. The carpet module being vacuum formed over a single hollow mold element. The mold element having a molding surface shaped to correspond to the shape of the vehicle floor and having a plurality of vacuum ports formed through the contoured surface. A vacuum pulling the air from the interior of the mold element and causes the vacuum ports to draw a heated carpet segment against the contoured surface and thereby shape the segment into a carpet module. The carpet segment is heated sufficiently soften the thermoplastic material which, upon subsequent cooling, hardens to retain the shape of the molding surface.

### BACKGROUND OF INVENTION

This invention relates in general to vehicle carpeting and in particular to a molded vehicle carpet module and a method for forming the carpet module with a vacuum molding process.

Motor vehicle floors are often covered by carpeting to enhance appearance and comfort while providing sound absorption within the vehicle passenger compartment. It is known to fabricate molded carpet modules for installation in automobiles, truck cabs, vans and utility vehicles. Such carpet modules reduce installation time and thus lower manufacturing costs. Additionally, the molded modules tend to be resistive to inadvertent handling damage.

Referring now to FIG. 1, there is shown a sectional view of a portion of a known molded vehicle carpet module 10. Vehicle carpet modules typically include a top layer of tufted carpeting 12. Tufted carpets are manufactured upon tufting machines that operate like a giant sewing machine containing hundreds of needles arranged side by side on a needle bar. A suitable pile yarn, which may be of any suitable composition, such as polyester, polypropylene or nylon, is threaded through the eye of each needle. Then the needles, moving simultaneously, stitch the yarn through a prewoven sheet of a suitable backing material 14, such as spun bonded polyester or woven polypropylene. Loopers in the tufting machine move close to each needle eye and engage the yarn. As each needle is pulled out of the backing material 14, a loop of yarn, or tuft, 16 is formed and held in place upon the backing material 14.

In order to securely adhere and lock the pile yarns into the carpet backing 14, the carpet 12 includes a suitable binder pre-coat layer 17 extends over the underside of the carpet backing 14, as is conventional practice in the manufacture of tufted carpets for residential or commercial building use. The pre-coat layer 17 typically includes Ethylene Vinyl Acetate (EVA) and/or low density polyethylene. The pre-coat layer 17 seals the carpet backing material 14 while providing fiber binding properties to the ends of the pile yarns. The looped pile may be left uncut, or the loops may be cut to form a plush surface. Typically, the closer the pile tufts 16 are to one another, the further the tufts 16 extend above the backing material and the heavier the pile yarn, the denser the carpet pile and the greater the ability of the carpet 12 to withstand wear.

The carpet module 10 also includes a coating or mass layer 18 that is formed from a polymer composition such as filled EVA and attached to the exposed surface of the pre-coat layer 17 that is opposite from the carpet backing 14. The filler can include calcium carbonate, barium sulfate, or similar compounds. While the pre-coat layer 17 typically has a weight in the range of 8-12 oz./yd.², the weight of the mass layer 18 is typically in the range of 30-136 oz./yd.² A primary function of the pre-coat layer 17 is to provide additional fiber binding properties while imparting a stiffness and moldability to the carpet 12 that allows molding of the carpet 12 into a three dimensional contoured configuration that conforms to the contours of the vehicle floor. The mass layer 18 imparts a sound deadening property that makes the interior of the vehicle quieter. To this end, the mass layer 18 may contain substantial proportions of filler materials, such as, for example, calcium carbonate, gypsum, barium sulfate, and the like.

Optional foam pads 20 may be bonded to the mass layer 18 to provide additional vibration and noise dampening. Typically, each of the foam pads 20 extend over only a portion of the mass layer 18. Optionally, the foam pads 20 may include fillers, such as glass beads, fibers, or the like, in order to vary the weight and density properties of the foam for optimal acoustical and cushioning properties. As shown in FIG. 1, the foam pad 20 includes a recessed portion 22 that conforms to the shape of the vehicle floor.

Methods for molding carpet modules are well know and described in U.S. Pat. Nos. 3,953,632 and 4,579,764. One such method is illustrated by the flow chart shown in FIG. 2. In functional block 23, a roll of carpet backing material is fed through a tufting machine while the machine needles stitch carpet yarn to the carpet backing material to form tufts 16. A pre-coat layer 17 is applied to the underside of the carpet backing 14 in functional block 24 by a conventional process, such as extrusion coating or calendering. A mass layer 18 is then applied to the pre-coat layer in functional block 25 by a conventional method, which again can be by extrusion coating or calendering.

After the application of the mass layer 18, the carpet is cut into segments in functional block 26. The carpet segments are heated in functional block 27 to soften the mass layer 18. Once the mass layer 18 is sufficiently softened, the carpet segments are subjected to a compression molding operation in functional block 28. During the compression molding operation, each carpet segment is pressed between a pair of co-operating mold dies, which are described below, in order to form the segment into a desired predetermined three dimensional configuration that corresponds to the shape of the vehicle floor. After the mass layer 18 has cooled sufficiently to retain the shape of the molding dies, the dies are opened and the molded carpet module 10 is removed from the die set 30.

In functional lock 29, optional foam pads 20 may be either attached with adhesive to the molded carpet module 10, or formed in situ by conventional Reaction Injection Molding (RIM). The later method produces foam pads that are autogeneously bonded to the thermoplastic layer without the necessity of additional adhesives. However, as described in the above mentioned U.S. Pat. No. 4,579,764, RIM requires a dedicated mold.

A sectional view of a typical known die set 30 that is used to compression mold the carpet module 10 is illustrated in FIG. 3. The die set comprises a upper die 32 and a lower die 34 that have mating surfaces shaped to correspond to the floor of a particular vehicle. The dies 32 and 34 are shown in their closed position in FIG. 3. The upper die 32 is typically formed from an epoxy material, such as resin reinforced fiberglass. As shown, the upper die includes a cast aluminum liner 36 that has a plurality of cooling channels 38 formed therein. The lower die 34 is typically cast from aluminum and also has a plurality of cooling channels 39 formed therein. Cooling water is circulated through the cooling channels 38 and 39 to accelerate the cooling of the carpet module 10.

The die set 30 is mounted upon a conventional press mechanism (not shown) that is operative to force the upper die 32 into the lower die 34 after a heated piece of carpet that includes a mass layer has been placed upon the lower die 34. As shown in FIG. 3, a carpet module 10 consisting of a piece of carpet 12 that includes a binder layer 17 and a mass backing layer 18 is disposed within the die set 30. Once the carpet module 10 has cooled sufficiently, the upper die 32 is withdrawn from the lower die 34 to allow removal of the module 10. Subsequently, foam pads 20 may be optionally added to the carpet module 10 as described above.

Conventional motor vehicle modules require dedicated die sets for their manufacture. Due to floor shape variations between different vehicle model lines, it is necessary to prepare, maintain and store a large number of dies. Accordingly, it would be desirable to simplify the process for manufacture of molded vehicle carpet modules. Additionally, the inventors have noticed that the compression molding process can produce carpet modules having a non-uniform thickness due to non-uniform distribution of the mass layer material during the molding process. Accordingly, it may be necessary to mold thick carpets to assure that the thinner portions of the carpet module provide the desired sound deadening is achieved. Therefore, any reduction in module thickness, while preserving the sound deadening capability of the carpet, would also provide a desirable reduction in the weight of the modules while also reducing the cost of the module since less material would be required.

### SUMMARY OF INVENTION

This invention relates to a molded carpet module for a motor vehicle and a method for forming the carpet module with a vacuum molding process.

The present invention contemplates a vehicle carpet module that includes a thermoplastic backing material that is shaped to correspond to the shape of a floor in a particular motor vehicle. A piece of tufted carpet is attached directly to the thermoplastic backing material to form a molded vehicle carpet. The carpet module also can optionally include at least one foam pad attached to a surface of the backing material that is opposite from said yarn tufts.

The present invention also contemplates a process for vacuum forming a vehicle carpet module that includes providing a carpet segment that includes a piece of tufted carpet attached directly to a piece of thermoplastic backing material. The carpet segment is heated sufficiently to soften the thermoplastic backing material. The heated carpet segment is placed over a contoured surface of a vacuum forming mold, the forming mold having a plurality of suction ports extending transversely through the contoured surface. A vacuum is drawn from within the mold, the vacuum causing the carpet segment to conform to the shape of the contoured surface. The carpet segment is then allowed to cool sufficiently for the backing material to retain the shape of the mold whereby the carpet segment is molded into a carpet module. Finally, the carpet module is removed from the mold.

The process can further include placing another mold member over the forming mold and carpet module, the mold member having at least one well formed therein. A foamable composition is injected into the well whereby at least one foam pad is formed that covers at least a portion of the carpet module thermoplastic backing material and is adhered thereto.

The invention further contemplates a vacuum forming mold including a hollow mold element that defines an internal chamber. The mold element also has a surface contoured to correspond to a vehicle floor shape. A plurality of vacuum ports extend through the contoured surface and communicate with the internal chamber. The mold also includes a vacuum generating device communicating with the mold internal chamber and operable to draw a vacuum from the internal chamber.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a sectional view of a known compression molded vehicle carpet module.

FIG. 2 is a flow chart illustrating a known process for compression forming the vehicle carpet module shown in FIG. 1.

FIG. 3 is a sectional view of a known compression mold die set used to form the vehicle carpet module shown in FIG. 1.

FIG. 4 is a sectional view of a vacuum molded carpet module in accordance with the invention.

FIG. 5 is a flow chart illustrating a process for vacuum forming the vehicle carpet module shown in FIG. 4.

FIG. 6 is a sectional view of a vacuum forming mold in accordance with the invention that is used to form the vehicle carpet module shown in FIG. 4.

FIG. 7 is a sectional view of an alternate embodiment of the vacuum forming mold shown in FIG. 6.

FIG. 8 is a sectional view of the alternate embodiment of the mold shown in FIG. 7 with a second mold member cooperating with the vacuum forming mold for forming in situ foam pads.

### DETAILED DESCRIPTION

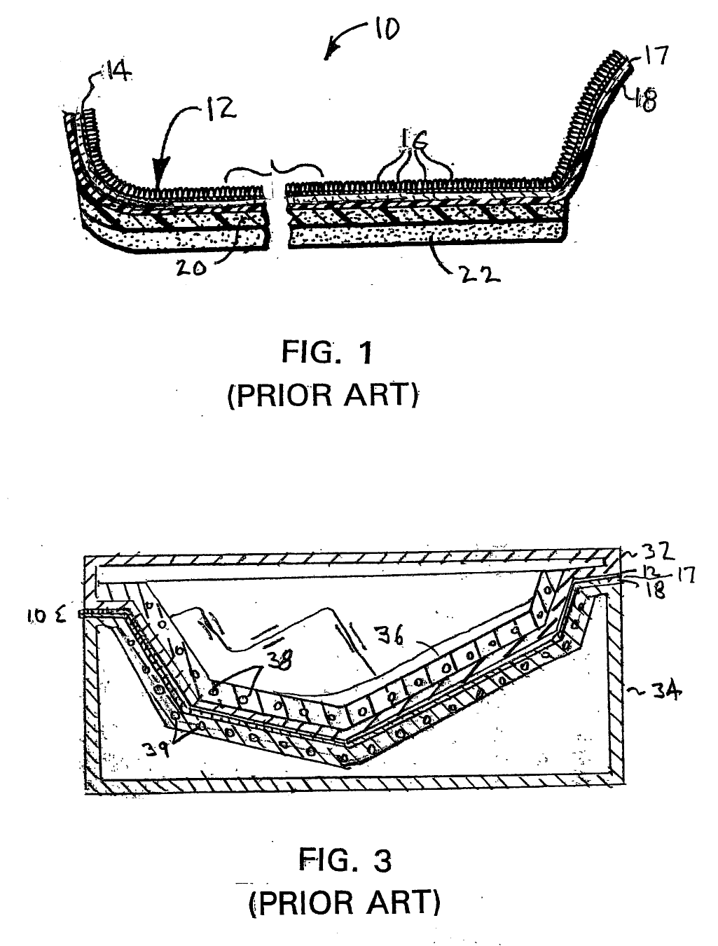

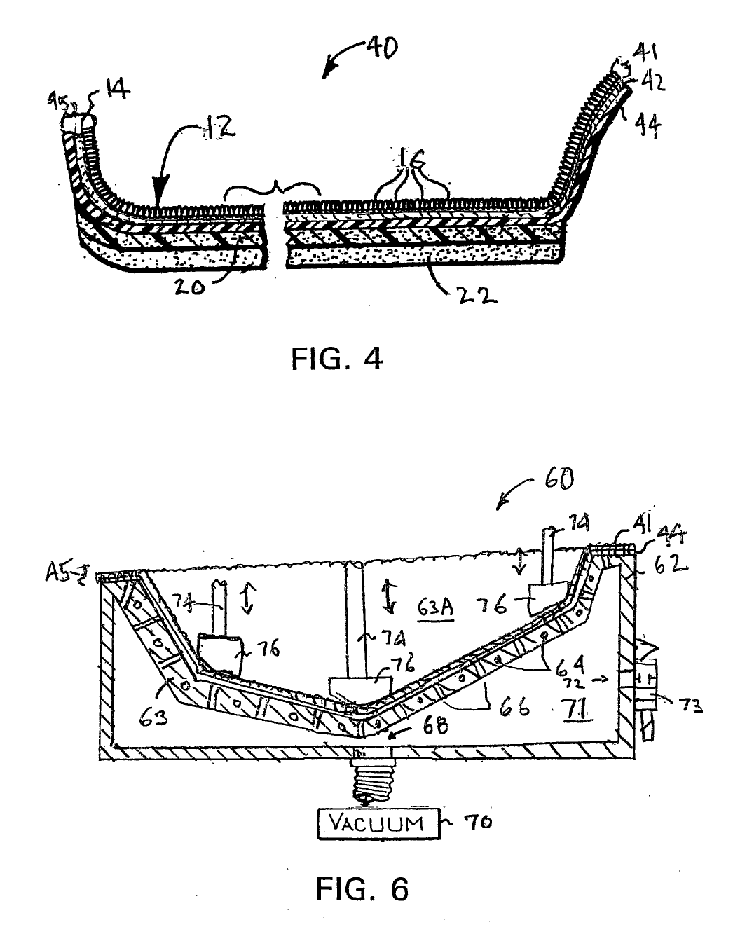

Referring again to the drawings, there is illustrated in FIG. 4 a cross sectional view of an improved motor vehicle carpet module 40 that is in accordance with the invention. Components shown in FIG. 4 that are similar to components shown in FIG. 1 have the same numerical identifiers. While the structure of the carpet module 40 shown in FIG. 4 appears to be similar to the structure of the carpet module 10 shown in FIG. 1, certain key materials are different and result in a significant improvement in important module characteristics. Additionally, the different material allows use of an alternate molding process that significantly reduces manufacturing costs while improving module characteristics. The carpet module 40 includes a plurality of pile yarn tufts 16 formed a suitable material, such as polyester, polypropylene or nylon, with nylon being used in the preferred embodiment. The weight of the yarn tufts 16 is typically in the range of 10-24 oz./yd.² The tufts 16 are stitched to a carpet backing material 14, such as spun bonded polyester or woven polypropylene, to form a piece of carpet 41. The weight of the carpet backing material is typically in the range of 3-4 oz./yd.² A pre-coat layer 42 formed from EVA is shown in FIG. 4; however, the pre-coat layer 42 is optional. The inventors have discovered that properties of the module 40 are sufficiently improved that the pre-coat layer 42 may be omitted, reducing both the weight and cost of the module 40. When applied, the pre-coat layer typically has a weight in the range of 8-12 oz./yd.²

A mass layer 44 of thermoplastic backing material is attached over the pre-coat layer 42, if present, or directly to the carpet backing layer 14, is the pre-coat layer 42 is absent. It is contemplated that the mass layer 44 is formed from one of a number of materials. One such material is compatibilized carpet scrap blend that is available from the Lear Corporation under the brand name Sonotec EP™ and which is described in U.S. Pat. Nos. 5,719,198, 5,852,115, 5,859,071 and 6,241,168, which are hereby incorporated by reference. Other materials include ultra low density polyethelene and modified polyproplene. It also is contemplated that filled versions of Sonotec EP™, low density polyethelene and modified polyproplene can be used to form the mass layer 44. Additionally, a filled version of metallocene co-polymers can be utilized. Fillers can include calcium carbonate and/or barium sulfate, with calcium carbonate being preferred. Typically, the weight of the mass layer 44 is in the range of 30-136 oz./yd.²

The thermoplastic backing material used for the mass layer 44 is more durable that typical prior art carpet backing materials. Also, the materials listed above for the mass layer 44 have hot strengths and melt strengths that are compatible with a vacuum forming that is described below and utilized to form the carpet module 40. The combined piece of carpet 41 and the mass backing layer 44 define a carpet segment 45 in the description below. As described above, foam pads 20 may be attached to the underside of the backing material 44 to further enhance the sound absorption capabilities of the carpet module 40 while also improving the feel thereof.

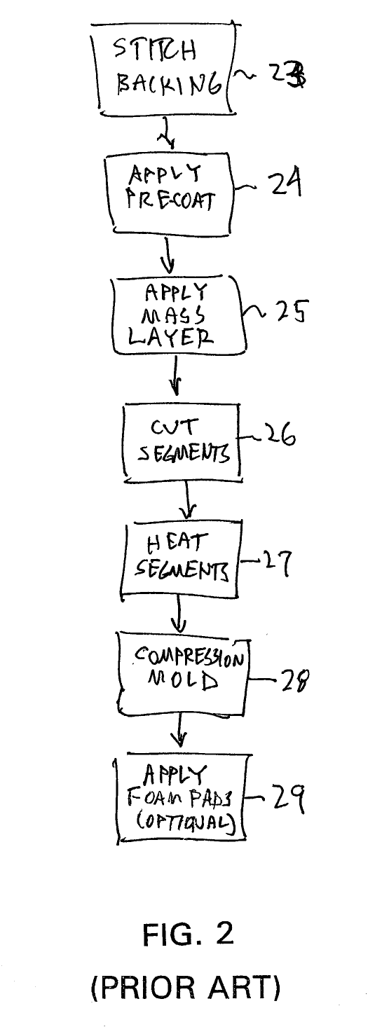

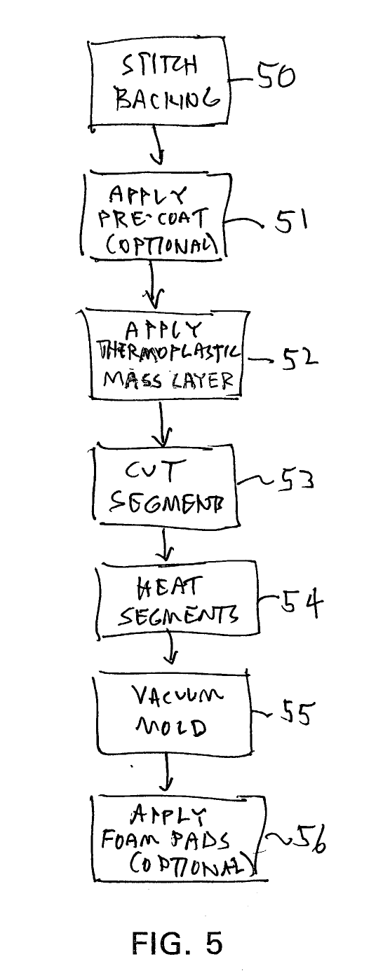

The fabrication of the carpet module 40 in accordance with the invention is illustrated by the flow chart shown in FIG. 5. Similar to the process described above, tufts 16 of carpet yarn are stitched onto carpet backing 14 in functional block 50 to form carpeting 41. A layer 42 of pre-coat is applied to the underside of the carpeting 41 in functional block 51; however, this step is optional and, in the preferred embodiment, is omitted. A thermoplastic mass layer 44 comprising one of the materials listed above is applied in functional block 52 by a conventional method, such as, extrusion coating or calendering. The layered carpeting is cut into segments in functional block 53. As described above, the segments are heated in functional block 54 to soften the thermoplastic material. The carpet segments are then vacuum molded in functional block 55 to the desired shape. The vacuum molding process will be described in detail below. Once the carpet modules have cooled sufficiently to retain their shape, optional foam pads may be applied to the undersurface of the modules in functional block 56. The pads may be either attached to the carpet modules with an adhesive, or they may be molded in situ as also will be described below. A comparison of the inventive process shown in FIG. 5 with the prior art process shown in FIG. 2 illustrates the simplification achieved with the process according to the present invention.

The invention also contemplates an improved vacuum forming mold 60, as shown in a sectional view in FIG. 6. The vacuum mold 60 consists of a single hollow body 62 that has an upper portion 63 shaped to from a mold cavity 63 A that corresponds to the floor of the specific vehicle that will receive the carpet modules 40. The mold body 62 can be formed of conventional material; however, in the preferred embodiment, the body 62 is cast from aluminum. Similar to the die set 30 described above, the mold body 62 has a plurality of cooling channels 64 formed across the die upper portion 63. The cooling channels 62 carry cooling water that accelerates the cooling of the carpet module 40 to increase the production rate of the forming mold 60.

A plurality of suction ports 66 extend transversely through the mold upper portion 63. An exhaust port 68 is formed through the bottom of the mold body 62 and is attached to a vacuum source 70. During operation, the vacuum source 70 pulls air from within the hollow interior chamber 71 of the forming mold 60. The mold body 62 also has an equalization port 72 formed therethrough. The equalization port 72 communicates with a normally closed solenoid valve 73. Upon actuation, the solenoid valve 73 opens the equalization port 72 to the outside atmosphere, allowing outside air to reenter the mold chamber 71 and thereby equalize the interior pressure with the exterior atmospheric pressure.

The forming mold 62 also can be optionally equipped with one or more pushers, or rams, 74, three of which are shown in FIG. 6, to draw the carpet material into the mold cavity 63A. Each of the rams 74 are connected to a conventional mechanism (not shown), such as hydraulically actuated cylinders, that force the rams 74 in a downward direction in FIG. 6 and into the forming mold cavity 63A. The mechanism also subsequently retracts the rams 74, as shown by the small double headed arrows. A head 76 mounted upon the lower end of each of the rams 74 is shaped to correspond to the adjacent area of the upper mold portion 63 when the ram 74 is extended into the forming mold cavity 63A.

The operation of the forming mold 60 will now be described. A precut segment 45 of tufted carpet that has been heated sufficiently to soften the thermoplastic mass backing material layer 44 is placed over the opening of the mold cavity 53 A with the carpet tufts 16 facing in a downward direction in FIG. 6. The vacuum source 70 is activated and draws air from within the interior chamber 71 and also, by means of the suction ports 66, from beneath the carpet segment 45. The resulting pressure differential that occurs across the carpet segment 45 urges the carpet segment 45 in a downward direction in FIG. 6 and into the forming mold cavity 63 A. The inventors note that the prior art filled EVA material typically used for the mass layer 18 of the prior art carpet modules 10 does not have a sufficient hot strength or melt strength for vacuum molding. Indeed, when a vacuum is applied by the forming mold 62 to a prior art carpet segment that includes a mass layer formed from filled EVA material, the prior art material is pulled through the suction ports 66.

For shallow mold cavities, the suction produced will be sufficient to draw the carpet segment completely into the mold cavity 63A. However, when the mold cavity is deep, the forming mold 60 includes one or more rams 74 that are activated to further urge the carpet segment 45 into the mold cavity 63A. The ram heads 76 are operative to spread the force over a portion of the carpet segment 45. Additionally, the shape of the ram head lower surfaces assures that the carpet is fully drawn into the mold cavity 63A.

Once the carpet segment is completely entered into the mold cavity 63A, the suction and, when used, the rams 74 press the carpet segment 45 against the surface of upper mold portion 63. A cooling fluid, such as water, is then circulated through the cooling channels 64 to cool the mass thermoplastic backing material layer 44 while the carpet segment 45 is held in conformance to the mold surface shape, thereby molding the carpet segment 45 to the shape of the vehicle floor. Once the mass thermoplastic backing material layer 44 has cooled sufficiently that the carpet module will retain the molded vehicle floor shape, the vacuum source 70 is deactivated. The equalization port 72 is then opened to allow equalization of the pressure on both sides of the carpet module 40, allowing the module 40 to be removed from the vacuum forming mold 60.

Thus, the present invention replaces the prior art two piece die set 30 with a single piece forming mold 60. Accordingly, the cost of providing a mold is reduced correspondingly while the maintenance and storage requirements associated with prior art two piece die sets are also reduced.

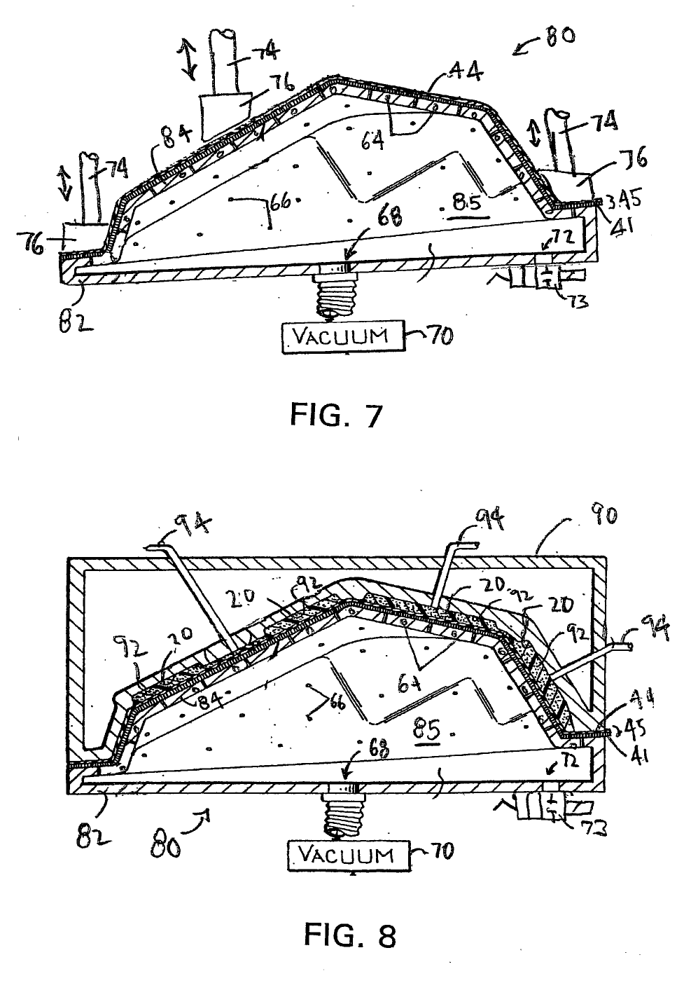

An alternate embodiment of the vacuum forming mold is shown at 80 in FIG. 7. Components of the mold 80 that are shown in FIG. 7 that are similar to components shown in FIG. 6 have the same numerical identifiers. Basically, the forming mold 80 corresponds to the upper die set member 32 shown in FIG. 3. The vacuum forming mold 80 includes a hollow mold body 82. A plurality of cooling channels 64 extend across the upper portion 84 of the mold body 82. A plurality of suction ports extend transversely through the mold upper portion 84. An exhaust port 68 is formed through the bottom of the mold body 62 and is attached to a vacuum source 70. During operation, the vacuum source 70 pulls air from a hollow interior chamber 85 of the forming mold 80. The mold body 82 also has an equalization port 72 formed therethrough. The equalization port 72 communicates with a normally closed solenoid valve 73. Upon actuation, the solenoid valve 73 opens the equalization port 72 to the outside atmosphere, allowing outside air to reenter the mold chamber 85 and thereby equalize the interior pressure with the exterior atmospheric pressure.

The forming mold 80 also can be optionally equipped with one or more pushers, or rams, 74, three of which are shown in FIG. 6, to press the carpet segment 42 against the upper portion 84 of the mold 80. Each of the rams 74 are connected to a conventional mechanism (not shown), such as hydraulically actuated cylinders, that force the rams 74 in downward direction in FIG. 6 against the upper surface of the forming mold 60. The mechanism subsequently retracts he rams 74, as shown by the small double headed arrows. A head 76 mounted upon the lower end of each of the rams 74 is shaped to correspond to the adjacent surface of the upper mold portion 84 when the ram 74 is extended onto the forming mold 80.

The operation of the forming mold 80 will now be described. A precut segment of tufted carpet 45 that has been heated sufficiently to soften the mass thermoplastic backing material layer 44 is placed over the upper portion 84 of the mold body 82 with the carpet tufts 16 facing in a downward direction in FIG. 7. The vacuum source 70 is activated and draws air from the mold interior chamber 85 and also, by means of the suction ports 66, from beneath the carpet segment 45. The resulting pressure differential that occurs across the carpet segment 45 urges the carpet segment 42 in a downward direction in FIG. 6 and against the surface of the upper portion 84 forming mold body 82.

For shallow molds, the suction produced will be sufficient to draw the carpet segment completely over the mold. However, when the mold is not shallow, as illustrated in FIG. 7, the forming mold 80 includes one or more rams 74 that are activated to further urge the carpet segment 45 against the mold body upper portion 84. The ram heads 76 are operative to spread the force over a portion of the carpet segment 45. Additionally, the shape of the ram head lower surfaces assures that the carpet is fully drawn over the mold body upper portion 84.

Once the carpet segment 45 is completely pressed against the mold 80, the suction and, when used, the rams 74 hold the carpet against the surface of upper mold portion 84. A cooling fluid, such as water, is then circulated through the cooling channels 64 to cool the mass thermoplastic backing material layer 44 while the carpet segment 45 is held in conformance to the mold surface shape, thereby molding the carpet segment 45 to the shape of the vehicle floor. Once the mass thermoplastic backing material layer 44 has cooled sufficiently that the carpet module will retain the molded vehicle floor shape, the vacuum source 70 is deactivated. The equalization port 72 is then opened to allow equalization of the pressure on both sides of the carpet module 40 allowing the module 40 to be removed from the forming mold 80.

The inventors have used the above described molds to produce vehicle carpet modules in accordance with their invention. The following table illustrates the results of test performed upon the vacuum formed carpet modules that have the improved inventive construction described above. The first column lists the specifications for the carpet. The second column lists test results for a similar prior art carpet module formed by compression molding. The third column lists test results obtained from a carpet module molded with the second described forming mold 80 with the carpet tufts adjacent to the vacuum mold surface. The fourth column lists test results obtained from a carpet module molded with the first described forming mold 60 with the mass layer adjacent to the vacuum mold surface:

| | | | 16 OZ | |
|---|---|---|---|---|
| | | | FACE | 16 OZ |
| | | | VACUUM | FACE |
| | | | MOLDED | VACUUM |
| | | 16 OZ FACE | CARPET | MOLDED |
| | | MOLDED | FACE | CARPET |
| | SPEC | NORMAL | DOWN | FACE UP |
| MASS | RESULTS | 1646 | 1784 | 1889 |
| ABRASION 2000 CYCLES | SAT | SAT | SAT | SAT |
| FIBER LOSS % | 0.05 | 0.03 | 0.01 | 0.01 |
| FLOSS GRAM WEIGHT | RESULTS | 0.17 | 0.036 | 0.047 |
| TUFTLOCK ORIGINAL | 13 | 23.41 | 28.42 | 32.16 |
| TUFTLOCK CYCLED | 13 | 30.9 | 35.8 | 32.48 |
| TUFTLOCK HEAT AGED | 13 | 20 | 34.18 | 31.04 |
| ABRASION TO FAIL | RESULTS | 3747 | 6697 | 5187 |

It is apparent from the above results that the invention produces carpet modules that are significantly better than prior art carpet modules. It is noted that the fiber loss with the improved carpet module is decreased by two thirds from the fiber loss for the prior art carpet module. Thus, the vacuum forming molding process produces a carpet module having fiber binding properties that are far superior over carpet modules formed with the prior art compression molding process. The inventors believe that the vacuum forming process causes a uniform dispersion of the mass backing material over the back of the carpet segment. Additionally, the abrasion to fail parameter has effectively doubled for the improved carpet module. This clearly indicates a significant improvement of carpet module durability for the improved module 40. The inventors have found that the vacuum forming method also produces a carpet module having a uniform thickness. Accordingly, the overall thickness of the mass backing layer can be reduced while providing the same level of sound absorption. The reduction of the thickness of the mass layer reduces both the carpet module weight and the cost of materials used in the module.

The present invention also contemplates using the vacuum forming mold 80 as part of a die set to form foam pads 20 upon the undersurface of the carpet module 40. The application is illustrated in FIG. 8, where components shown in FIG. 8 that are similar to components shown in the preceding figures have the same numerical identifiers. An upper mold element 90 is lowered over the forming mold 80 and the carpet module 40 once the module 40 has cooled sufficiently. The upper mold element 90 is shaped to conform to the floor of the vehicle associated with the carpet module 40. The interior surface of the upper mold 90 has a plurality of wells 92 formed therein that correspond to the locations and shapes of the desired foam pads 20. Each well 92 communicates with an injector nozzle 94. Once upper mold element 90 has closed over the forming mold 80 and carpet module 40, a foamable composition is injected through the nozzles 94 and into the wells 92. The foamable composition expands to fill the wells 92 and then hardens and cures to form resilient foam pads 20 of the desirable size and shape. The foam pads 20 are fusibly bonded to the mass thermoplastic carpet backing layer 44.

By utilizing the vacuum forming mold 80 with the upper mold element 90, a complete separate set of molds that is required by the prior art method for forming the foam pads is eliminated. Accordingly the complexity and cost of manufacture of the carpet modules is further reduced. The present invention effectively reduces the required mold elements by a factor of two.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A modular carpet for a motor vehicle comprising:
a thermoplastic backing material that is vacuum molded to correspond to the shape of a floor in a particular motor vehicle; and
a piece of tufted carpet attached to said backing material to form a molded vehicle carpet.

2. The carpet module according to claim 1 further including a pre-coating of EVA disposed between said thermoplastic backing material and said piece of tufted carpet.

3. The carpet module according to claim 1 further including at least one foam pad attached to a surface of said backing material that is opposite from said tufted carpet.

4. The carpet module according to claim 1 wherein said thermoplastic backing material includes one of the group of Sonotec EP™, ultra low density polyethelene and modified polyproplene.

5. The carpet module according to claim 4 wherein the thermoplastic backing material includes selected from the group of calcium carbonate and barium sulfate.

6. The carpet module according to claim 1 wherein said thermoplastic backing material includes a filled metallocene co-polymer.

7. A process for vacuum forming a vehicle carpet module comprising the steps of:
(a) providing a carpet segment that includes a piece of tufted carpet attached directly to a piece of thermoplastic backing material;
(b) heating the carpet segment sufficiently to soften the thermoplastic backing material;
(c) placing the heated carpet segment over a vacuum forming mold, the forming mold having a surface contoured to correspond to the shape of a vehicle floor, said mold also having a plurality of suction ports extending transversely through the contoured surface of the mold;
(d) drawing a vacuum from within the mold, the vacuum causing the carpet segment to conform to the shape of the contoured surface of the forming mold;
(e) allowing the carpet segment to cool sufficiently for the thermoplastic backing material to retain the shape of the mold whereby the carpet segment is molded into a carpet module; and
(f) removing the carpet module from the mold.

8. The process according to claim 7 further including, subsequent to step (e), placing another mold member over the forming mold and carpet module, the mold member having at least one well formed therein and injecting a foamable composition into the well whereby at least one foam pad is formed that covers at least a portion of the thermoplastic backing material and is adhered thereto.

9. The process according to claim 7 further including, subsequent to step (f), adhesively attaching at least one foam pad to the thermoplastic backing material of the carpet module with the foam pad covering at least a portion of the thermoplastic backing material.

10. The process according to claim 7 wherein the mold includes a plurality of cooling channels formed adjacent to the mold contoured surface and further wherein, during step (e), a cooling fluid is circulated through the cooling channels to accelerate the cooling of the thermoplastic backing material.

11. The process according to claim 7 wherein the carpet segment provided in step (a) includes a thermoplastic backing material selected from the group of Sonotec EP™, ultra low density polyethelene and modified polyproplene.

12. The carpet module according to claim 11 wherein the thermoplastic backing material includes selected from the group of calcium carbonate and barium sulfate.

13. The carpet module according to claim 7 wherein the thremopastic backing of the carpet segment provided in step (a) includes a filled metallocene co-polymer.

14. A vacuum forming mold for vehicle carpet modules, the mold comprising:
a hollow mold element having a surface contoured to correspond to the floor shape of a motor vehicle, said hollow mold element defining an internal chamber;
a plurality of vacuum ports extending through said contoured surface and communicating with said internal chamber; and
a vacuum generating device communicating with said internal chamber and operable to draw a vacuum from said internal chamber.

15. The mold according to claim 14 further including an equalizing port communicating with said internal chamber, said equalizing port connected to valve, said valve operable to open and allow said equalizing port to admit atmospheric pressure through said equalizing port and into said internal chamber.

16. The mold according to claim 15 further including at least one ram, said ram operable to urge a segment of carpet material against said contoured surface of said mold element.

17. The mold according to claim 15 further including a plurality of cooling channels formed adjacent to the mold contoured surface and a device for circulating a cooling fluid through the cooling channels.
